(19) United States
(12) Patent Application Publication
(10) Pub. No.: US 2009/0104382 A1
(43) Pub. Date: Apr. 23, 2009

(54) Artificial marble and methods

(76) Inventors: Ruti Harel, Kibbutz Sdot-Yam (IL); Yaakov Gal, Kibbutz Sdot-Yam (IL)

Correspondence Address: EMPK & Shiloh, LLP;c/o Landon IP, Inc., 1700 Diagonal Road, Suite 450, Alexandria, VA, 22314, US

(21) Appl. No.: 12/232,845

(22) Filed: Sep. 25, 2008

Related U.S. Application Data
(60) Provisional application No. 60/960,323, filed on Sep. 25, 2007.

(51) Int. Cl. B32B 9/00

(52) U.S. Cl. 428/15; 523/171

(57) ABSTRACT

There is provided a composite stone material that includes recycled composite stone material. There is further provided a method for the preparation of a composite stone material slab comprising recycled composite stone material, said method includes mixing recycled composite stone material into a mixture of raw composite stone material and one or more additional additives to obtain a composite stone material slab.

### RELATED APPLICATION

The present application claims benefit under 35 U.S.C. 119(e) of U.S. Provisional Application 60/960,323, filed Sep. 25, 2007, the entire disclosure of which is incorporated herein by reference.

### BACKGROUND

Quartz is the most common oxide on the surface of the earth. Quartz is the crystalline form of silicon dioxide (SiO₂) and is one of the hardest materials in nature. Among many other uses, quartz may be used for the production of various stone materials. The quartz containing stone materials may be used, for example, in the preparation of slabs, surfaces, and the like. Quartz containing stone material may be used for various purposes, such as, for example: interior wall cladding, fireplace mantles and surroundings, wainscots and wall bases, bank teller lines, tables and desktops, elevator cab walls and floors, floor tile and stair treads, food service areas, shower and tub surrounds, toilet compartment partitions, window seats, countertops and backlashes.

As compared to other natural stone compositions, such as granite and marble, quartz containing stone material may be stronger and more durable than natural stone compositions. In addition, quartz containing stone material may be cleaner, safer and more consistent than other stone surfaces. Furthermore, quartz containing stone materials may be more resistant to: breakage, scratching, stain, heat, chemicals, freeze-thaw damage, and the like.

The production of quartz containing stone material may involve mixing inorganic quartz matrix and organic polymers that may be bound by linker compounds. The binding between the inorganic quartz matrix and the organic polymers may influence the resistance of the final composition of the quartz containing stone material. The process for the production of composite stone material may further yield various waste products.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other advantages or improvements.

According to some embodiments, there is provided a composite stone material slab, such as, for example, an artificial marble slab, that may include recycled composite stone material. The recycled composite stone material may comprise about 1% to 99% of the mixture of the composite stone material. The recycled composite stone material may comprise about 25% to 75% of the mixture of the composite stone material. The recycled composite stone material may include particles of composite stone material, waste products collected during the process of the preparation of composite stone materials, or any combination thereof.

According to some embodiments, the recycled particles of composite stone material may include particles of composite stone material that may form upon grinding, breaking, crushing and the like, of slabs of composite stone materials. The particles may include any size, such as in the range of about 0.065 mm to 10 mm. The particles of composite stone material may have any form and shape, such as, for example, round, square, spiked, triangular, quadrangular, and the like, and may also be amorphous.

According to some embodiments, the recycled waste products of composite stone material may include debris, and the like, that are produced as by-products in a preparation process of composite stone slab, prior to the curing of the slab. The waste products may be collected, compressed and cured. The cured waste products may be ground, broken, crushed, and the like, and used for the preparation of composite stone material. The recycled waste products may be crushed to any particle size, such as, for example, in the range of about 0.065 mm to 10 mm. The particle size may include the largest diameter of the particle, the longest dimension of the particle, and the like. The crushed recycled waste products may have any form and shape, such as, for example, round, square, spiked, triangular, quadrangular, and the like and may also be amorphous.

According to further embodiments, there is provided a method for the preparation of a composite stone slab, which includes recycled composite stone material, wherein the method includes mixing recycled composite stone material into a mixture of raw composite stone material and one or more additives, to obtain a composite stone material slab.

According to some embodiments, the mixture of raw composite stone material may include silicon, basalt, glass, diamond, rocks, pebbles, shells, quartz containing materials, or any combination thereof. The one or more additives may include: resin, binders, colorants, dyes, pigments, chemical reagents, antimicrobial reagents, or any combination thereof.

According to some embodiments, the recycled composite stone material may comprise about 1% to about 99% of the composite stone mixture. The recycled composite stone material may comprise about 25% to about 75% of the composite stone mixture.

According to additional embodiments, the recycled composite stone material may include particles of composite stone material, waste products of composite stone material, or any combination thereof. The particles of composite stone material may be obtained by grinding, breaking, crushing, or any combination thereof, of slabs of composite stone material. The waste products of composite stone material may include debris, which are produced in a preparation process of composite stone slab, prior to curing the slab.

According to further embodiments, the size of the recycled composite stone material may be in the range of about 0.065 mm to about 10 mm. The shape of the recycled composite stone material may be a round shape, square shape, spiked shape, triangular shape, quadrangular shape, amorphous shape, or any combination thereof.

In addition to the exemplary aspects and embodiments described above, further aspects and embodiments will become apparent by reference to the figures and by study of the following detailed descriptions.

### BRIEF DESCRIPTION OF THE FIGURES

FIG. 1—photograph of a portion of a composite stone material slab, according to some embodiments;

FIG. 2—an illustration of a method of producing a composite stone material, according to some embodiments.

### DETAILED DESCRIPTION

In the following description, various aspects of the invention will be described. For the purpose of explanation, specific configurations and details are set forth in order to provide a thorough understanding of the invention. However, it will also be apparent to one skilled in the art that the invention may be practiced without specific details being presented herein. Furthermore, well-known features may be omitted or simplified in order not to obscure the invention.

A composite stone material, such as, for example, artificial marble/engineered stone/quartz surfaces/composite stone, may be composed of various materials. For example, a composite stone material may be composed mainly of organic polymer(s) and inorganic particulate component. The inorganic particulate component may include such components as silicon, basalt, glass, diamond, rocks, pebbles, shells, a variety of quartz containing materials, such as, for example, but not limited to: crushed quartz, sand, quartz particles, and the like, or any combination thereof. For example, the inorganic quartz material may include sand of various particle sizes and in different combinations. Linkage between the organic and inorganic compounds may be carried out and/or facilitated by using binder molecules, such as, for example, mono-functional or multifunctional silane molecules, dendrimeric molecules, and the like, that may have the ability to bind the organic and inorganic components of the composite stone. The binders may further include a mixture of various components, such as initiators, hardeners, catalysators, binding molecules and bridges, or any combination thereof. The manufacturing process of the composite stone material may include blending of raw material (such as inorganic quartz and organic polymers, unsaturated polymers, and the like, such as polyester) at various ratios. For example, the composite stone material may include about 8-95% natural quartz aggregates to about 5-15% polymer resins. For example, the composite stone material may include about 93% natural quartz aggregates and about 7% polymer resins. In addition, any desired amounts of various additives, may be added to blending of raw materials, at various stages of production. For example, such additives may include, colorants, dyes, pigments, chemical reagents, antimicrobial substances, fungicidal agents, and the like or any combination thereof. As a result of adding various additives to the blending of raw materials, the additives may be present in the final composite stone product and may further change various characteristics of the composite stone. Such characteristics may include, for example, physical properties, such as: color, texture, display pattern, and the like; chemical properties, such as, for example, chemical resistance, pH properties, and the like; biological properties, such as, for example, antibacterial properties, and the like; and mechanical properties, such as, for example, strength, scratch resistance, impact resistance, and the like. The resulting mixture may later be poured to a support or a temporary support, such as rubber, paper, plastic or any other polymeric material, water soluble paper, silicon sheet or the like with or without a support frame or a shaping frame, a mold such as a rubber tray mold or any other appropriate support. The mixture is poured substantially in the form of a desired slab (for example, at a size of 306 cm×144 cm with or without wall shaping). The mixture may then be compacted by a special vacuum and vibration process, such as vibrocompaction at high pressure such as about 100 tons. Then, the compressed mixture may be placed in a curing and/or hardening kiln, for example, at a temperature in the range of 80° C. to 115° C. for 30 to 60 minutes until it hardens and assumes natural stone properties, but with greater performance and higher resistance to stains and impact, as detailed below. After completion of the casting process, the slabs may be flattened, gauged, calibrated and polished to a high and enduring shine or any desired finish to be used at various settings, such as, for example, interior wall cladding, fireplace mantles and surroundings, wainscots and wall bases, bank teller lines, tables and desktops, elevator cab walls and floors, floor tile and stair treads, food service areas, shower and tub surrounds, toilet compartment partitions, window seats and countertops.

Thus, composite stone material that may be composed mainly of organic polymer(s) and inorganic quartz matrix manufactured as described hereinabove may posses enhanced properties as compared to natural stones. In addition, the composite stone material may also include a desired appearance/design that may be different as compared to natural stone. For example, the composite stone material may include various display patterns, colors, textures, and the like that may be determined through the process for the preparation of the composite stone material.

As referred to herein, the terms, “composite stone material”, “artificial marble”, “engineered stone” and “quartz surfaces” may interchangeably be used.

As referred to herein, the term “waste products” may relate to any debris, residual composition, and the like, comprised mainly of composite stone material mixtures that may form during the manufacturing process of composite stone material and composite stone material slabs.

As referred to herein, the term “particles of composite stone material” may relate to any particle of composite stone material that may form when prepared slabs or part of slabs of composite stone material are ground and/or broken and/or crushed.

As referred to herein, the terms “unused”, “unwanted” may relate to any product that is not used for the purpose for which it was made. The term may also relate to any unused portion of slabs of composite stone material.

As referred to herein, the term “slab” also relates to any piece/region/portion of a slab.

As referred to herein, the terms “recycled material”, “recycled composite stone material” may interchangeably be used and may relate to any “waste products” and/or “particles of composite stone material”.

In the process of the preparation of the composite stone material, debris and residual compositions of composite stone material that have not formed into slabs of composite stone material may form. The debris may form at any of the stages of the manufacturing process of the composite stone material. Such debris and residual compositions may be considered as waste products. When preparing high quantities of artificial stone compositions, substantial amounts of such waste products may accumulate. The accumulation of such waste products may result in increased volume of trash that may impose a heavy burden on the environment. The heavy burden on the environment may result in environmental damage, such as, for example global warming, pollution of water sources, and the like; and there is, therefore, a need to reduce the amount of trash that may result from the accumulation of composite stone material waste products.

According to some embodiments, waste products, such as debris and residual compositions of composite stone material that may otherwise accumulate to trash may be recycled. Recycling of the waste products may have a favorable effect on the environment. Recycling of the waste products may reduce environmental damage by lowering the amount of trash in the environment. For example, recycling of such waste products may include using the waste products for the preparation of new slabs of composite stone material.

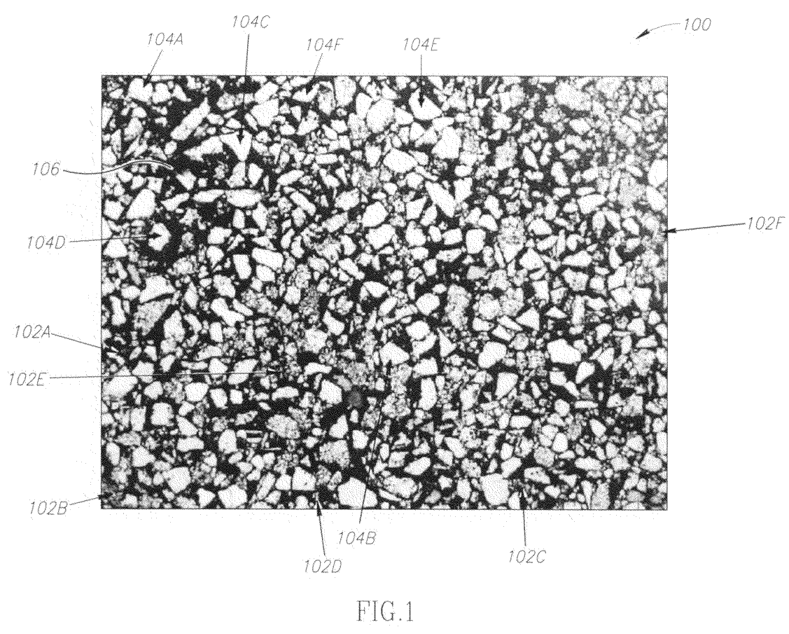

According to some embodiments, waste products, such as debris and residual compositions of composite stone material, may be recycled and used in the preparation of composite stone material and composite stone material slabs. To this aim, the waste products that may form at any stage of the manufacturing process of a composite stone/engineered stone slab may be collected. The waste products may further be compacted and then cured, for example, in a curing kiln. The resulting cured (hardened) waste product may further be ground/crushed/broken to any desired particle size, such as, for example to a size of, 0.065 mm to 10 mm. The particle size may include the largest diameter of the particle, the longest dimension of the particle, and the like. The resulting particles may be added to a mixture of artificial stone composition that may be formed into slabs, according to the process detailed hereinabove. The waste products, such as debris and residual compositions of composite stone material, may include any size, such as, for example, 0.065-10 mm. The cured and crushed waste products, such as debris and residual compositions of composite stone material, may have any form and shape, such as, for example, round, square, spiked, triangular, quadrangular and the like and may also be amorphous. The waste products may further have any color. For example, the cured and crushed waste products, such as debris and residual compositions of composite stone material, may be added to the mixture of raw material (such as, for example, with the inorganic quartz), along with the various additives (such as resin, binders, pigments, chemical reagents, antimicrobial reagents and the like) or at any other stage of the manufacturing process. The cured and crushed waste products, such as debris and residual compositions of composite stone material added to the raw mixture may include any amount and any percentage of the mixture. For example, the waste products, such as debris and residual compositions may comprise about 1% to 99% of the mixture. For example, the waste products, such as debris and residual compositions may comprise about 25% to 75% of the mixture. The specific density of the cured waste products of composite stone material may be substantially the same as the specific density of the composite stone slab. The resulting slabs thus manufactured may exhibit a display pattern in which the waste products, such as debris and residual compositions of composite stone material, may be identified. For example, FIG. 1 is a representative picture of a region of a composite stone material slab, whose manufacturing process included addition of waste products, such as debris and residual compositions of composite stone material. As shown in FIG. 1, in the composite stone material slab (such as slab 100), waste products (such as waste products 102A-F) may be identified. The waste products may be displayed as small rounded particles that may be scattered throughout the composite stone material slab composition (such as 106, displayed as black background).

The preparation process of composite stone material may also result in slabs (and/or parts of slabs) of composite stone material that may be chosen not to be used. Such unwanted/unused slabs may be discarded by the manufacturer of the slabs. Reasons for discarding such slabs may include, for example, aesthetic reasons, such as impurities, undesired color, undesired appearance and the like; mechanical reasons, such as, scratches, breaks, deformations, irregularities, and the like; quality control reasons; leftovers that may remain after using the composite stone material, or any combination thereof. Discarding unwanted slabs may result in an accumulation and increasing volume of trash. Such accumulation of trash may impose a heavy burden on the environment. The heavy burden on the environment may result in environmental damage, such as, for example, global warming, pollution of water sources and the like, and there is therefore a need to reduce the amount of trash that may result from the accumulation of unwanted slabs of composite stone material.

According to some embodiments, unwanted/unused slabs or parts of slabs of composite stone material that may otherwise accumulate to trash may be recycled. Recycling of the unwanted/unused slabs or parts of slabs of composite stone material may have a favorable effect on the environment. Recycling of the waste products may reduce environmental damage by lowering the amount of trash in the environment. For example, recycling may include reuse of the unwanted/unused slabs or parts of slabs of composite stone material for the preparation of new slabs of composite stone material.

According to some embodiments, unwanted/unused slabs or parts of slabs of composite stone material may be recycled and used in the preparation of composite stone material and composite stone material slabs. To this aim, the unwanted slabs may be crushed/ground (broken) by any method, such as, for example, by a grinder device, application of pressure, hammering, breakage, crushing, and the like, to produce particles of composite stone material. The grinding (breaking/crushing) may include grinding to a particle size of, for example 0.065 mm to 10 mm. The particle size may include the largest diameter of the particle, the longest dimension of the particle, and the like. The particles of composite stone material may have any form and shape, such as, for example, round, square, spiked shape, triangular, quadrangular, and the like, and may also be amorphous. The particles of composite stone material may further have any color. The particles of composite stone material may be added to a mixture of artificial stone composition to be formed into slabs. For example, the particles of composite stone material may be added to the mixture of raw material (for example, with the inorganic quartz fraction), along with the various additives (such as resin, binders, pigments, chemical reagents, antimicrobial reagents and the like) or at any other stage of the manufacturing process. The particles of composite stone material added to the raw mixture may include any amount, and any percentage of the mixture. For example, particles of composite stone material may comprise about 1% to 99% of the mixture. For example, particles of composite stone material may comprise about 25% to 75% of the mixture. The specific density of the particles of composite stone material may be substantially the same as the specific density of the composite stone slab. The resulting slabs thus manufactured may exhibit a display pattern, in which the particles of composite stone material may be identified. For example, FIG. 1, is a representative picture of a region of a composite stone material slab, whose manufacturing process included addition of particles of composite stone material. As shown in FIG. 1, in the composite stone material slab (such as slab 100), particles of composite stone material slabs (such as representative particles 104A-F) may be identified. The particles may exhibit various shapes, such as round-like shapes, diamond-like shapes, triangular shapes, quadrangular shapes, pentagonal shapes, spiked shapes, and the like, and may be scattered in the composite stone material slab composition (106, displayed as black background in FIG. 1). The specific density of the particles may be substantially as that of the composite stone material slab.

According to additional embodiments, and as exemplified in FIG. 1, recycled composite stone material may be used for the preparation of composite stone material and composite stone material slabs. Such recycled composite stone material may include any combination of particles of composite stone material (produced by grinding of unwanted/unused slabs of composite stone material, as detailed hereinabove) and cured and crushed waste products, such as debris and residual compositions of composite stone material (as detailed hereinabove). For the production of composite stone material and composite stone material slabs, the recycled composite stone material (particles of composite stone material and/or cured and crushed waste products) may be added to a mixture of raw material (such as with the inorganic quartz fraction), along with various additives (such as resin, binders, colorants, dyes, pigments, chemical reagents, antimicrobial reagents, and the like), or at any stage of the manufacturing process. The recycled composite stone material added to the raw mixture may include any amount and any percentage of the mixture. For example, the recycled composite stone material may comprise about 1% to 99% of the mixture. For example, the recycled composite stone material may comprise about 25% to 75% of the mixture. The specific density of the recycled composite stone material may be substantially the same as the specific density of the composite stone slab. The resulting slabs thus manufactured may exhibit a display pattern in which the recycled composite stone material may be identified. For example, as shown in FIG. 1, which is a representative picture of a portion of a composite stone material slab, whose manufacturing process included addition of recycled composite material, the composite stone material slab (such as slab 100) may include waste products (such as particles 102A-F) as well as particles of composite stone material slabs (such as particles 104A-F). The recycled composite stone material may vary in size, may include various forms and shapes, such as round, spiked, triangular, quadrangular, and the like, and may further be scattered in the composite stone material slab.

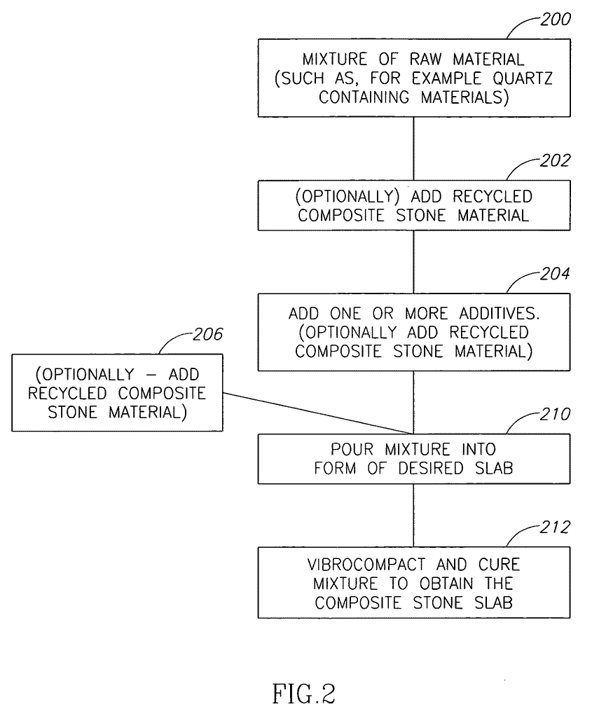

Reference is now made to FIG. 2, which schematically illustrates a method for the preparation of composite stone material and composite stone material slabs, which includes recycled composite stone. As shown in FIG. 2, to a mixture of raw material (which includes, for example, silicon, basalt, glass, diamond, rocks, pebbles, shells, quartz containing materials, crushed quartz, sand, quartz particles, or any combination, step 200), recycled composite stone material is added (step 202). The recycled composite stone material may include any combination of particles of composite stone material (produced by grinding of unwanted/unused slabs of composite stone material, as detailed hereinabove) and cured and crushed waste products, such as debris and residual compositions of composite stone material. In addition, as shown in step 204, one or more additives may be added. The additives may include such additives as, but not limited to: resin, binders, colorants, dyes, pigments, chemical reagents, antimicrobial reagents, and the like, or any combination thereof. The recycled composite stone material may optionally be added to the mixture at any stage of preparation. For example, the recycled composite stone material may be added prior to the additives (step 202), simultaneously with the additives (optionally in step 204), after the addition of the additives (optional step 206), or any combination thereof. The addition of the recycled composite stone material to the mixture may be repeated more than one time, and may be performed at various stages of the preparation process. In addition, the recycled composite stone material added to the mixture may include any amount, and any percentage of the mixture. For example, the recycled composite stone material may comprise about 25% to 75% of the mixture. Next, as shown in stage 210, the resultant mixture is poured in the form of a desired slab. At step 212, the mixture is then vibrocompacted and cured to obtain the composite stone slab, which includes recycled composite stone material.

While a number of exemplary aspects and embodiments have been discussed above, those of skill in the art will recognize certain modifications, permutations, additions and sub-combinations thereof. It is, therefore, intended that the following appended claims and claims hereafter introduced be interpreted to include all such modifications, permutations, additions and sub-combinations as are within their true spirit and scope.

1. A composite stone slab comprising recycled composite stone material.

2. The slab of claim 1, wherein said recycled composite stone material comprises particles of composite stone material, waste products of composite stone material or any combination thereof.

3. The slab of claim 2, wherein said particles are obtained by grinding, breaking, crushing, or any combination thereof, of composite stone slabs.

4. The slab of claim 2, wherein the particles size is in the range of about 0.065 mm to about 10 mm.

5. The slab of claim 2, wherein the particles shape comprises a round shape, square shape, spiked shape, triangular shape, quadrangular shape, amorphous shape, or any combination thereof.

6. The slab of claim 2, wherein said waste products of composite stone material comprise debris, produced in a preparation process of composite stone slab prior to curing the slab.

7. The slab of claim 2, wherein said waste products are compressed, cured, or both, prior to compressing and curing the slab.

8. The slab of claim 7, wherein the cured waste products are further processed by grinding, breaking, crushing, or any combination thereof.

9. The slab of claim 8, wherein the size of said processed waste products is in the range of about 0.065 mm to 10 mm.

10. The slab of claim 8, wherein the shape of said processed waste products comprises a round shape, square shape, spiked shape, triangular shape, quadrangular shape, amorphous shape, or any combination thereof.

11. The slab of claim 1, wherein said recycled composite stone material comprises about 1% to about 99% of the composite stone mixture.

12. A method for the preparation of a composite stone slab comprising recycled composite stone material, said method comprising:
mixing recycled composite stone material into a mixture of raw composite stone material and one or more additives to obtain a composite stone material slab.

13. The method of claim 12, wherein said mixture of raw composite stone material comprises silicon, basalt, glass, diamond, rocks, pebbles, shells, quartz containing materials, or any combination thereof.

14. The method of claim 12, wherein said one or more additives comprises: resin, binders, colorants, dyes, pigments, chemical reagents, antimicrobial reagents, or any combination thereof.

15. The method of claim 12, wherein said recycled composite stone material may comprise about 1% to about 99% of the composite stone mixture.

16. The method of claim 12, wherein said recycled composite stone material comprises particles of composite stone material, waste products of composite stone material, or any combination thereof.

17. The method of claim 16, wherein said particles are obtained by grinding, breaking, crushing, or any combination thereof, of slabs of composite stone materials.

18. The method of claim 16, wherein said waste products of composite stone material comprise debris, which is produced in a preparation process of a composite stone slab prior to curing the slab.

19. The method of claim 12, wherein the size of the recycled composite stone material is in the range of about 0.065 mm to about 10 mm.

20. The method of claim 12, wherein the shape of the recycled composite stone material comprises a round shape, square shape, spiked shape, triangular shape, quadrangular shape, amorphous shape, or any combination thereof.
